(19) United States
(12) Patent Application Publication
(10) Pub. No.: US 2013/0019653 A1
(43) Pub. Date: Jan. 24, 2013

(54) SENSOR CONTROL DEVICE

(71) Applicant: Shingo NAKATA, Kariya-city (JP)

(72) Inventor: Shingo NAKATA, Kariya-city (JP)

(73) Assignee: DENSO CORPORATION, Kariya-city (JP)

(21) Appl. No.: 13/552,947

(22) Filed: Jul. 19, 2012

(30) Foreign Application Priority Data
Jul. 20, 2011 (JP) 2011-158611

(51) Int. Cl. G01M 15/10

(52) U.S. Cl. 73/23.33

(57) ABSTRACT

A sensor control device is adapted for an engine including an exhaust passage along which an exhaust purification catalyst and a particulate matter detection sensor are disposed. The exhaust purification catalyst 14 purifies a given gas component included in exhaust gas. The particulate matter detection sensor includes an attaching part, to which conductive PM included in exhaust gas is attached, PM including more than one component. The particulate matter detection sensor outputs a detection signal that is in accordance with a weight of PM attached to the attaching part. The particulate matter detection sensor includes an upstream detection sensor that is disposed on an upstream side of the exhaust purification catalyst in a flow direction of exhaust gas. The device includes a particle number calculation unit that calculates a particle number of PM in exhaust gas based on the detection signal outputted by the upstream detection sensor.

### CROSS REFERENCE TO RELATED APPLICATION

This application is based on Japanese Patent Application No. 2011-158611 filed on Jul. 20, 2011, the disclosure of which is incorporated herein by reference.

### TECHNICAL FIELD

The present disclosure relates to a sensor control device that calculates the amount of particulate matter (PM) based on a detection signal of a particulate matter detection sensor.

### BACKGROUND

Conventionally, it is proposed against a backdrop of the regulation of PM to dispose a particulate matter detection sensor (PM sensor) that detects the amount of PM in exhaust gas discharged from an engine in an exhaust passage of the engine so as to monitor a PM discharge amount. For example, a PM sensor described in JP-A-2009-144577 is configured such that a pair of opposite electrodes are provided on an insulating substrate, and that the PM amount is detected through the measurement of interelectrode resistance by means of a change of the interelectrode resistance upon deposition of PM between the pair of opposite electrodes. In addition, PM includes a soluble organic fraction (SOF) which dissolves in organic solvent, and soot and sulfate as insoluble fractions.

In the above PM sensor having the configuration described in JP-A-2009-144577, when the PM amount is calculated based on a sensor detection signal, the PM amount is calculated as weight. For the PM regulation, two kinds of regulations on the PM weight and PM particle number in exhaust gas are under consideration. In the case of detection of the PM particle number using a weight-detection type PM sensor as described above, for example, average particle mass of the particulate matter attached to the PM sensor may be set beforehand; and the PM weight may be converted into the PM particle number by dividing the PM amount (weight) detected by the PM sensor by the average particle mass.

Under the present PM regulation, object components to be regulated are different between the PM weight and PM particle number. In the PM weight regulation, three components of soot, SOF, sulfate among the PM components are regulation targets, whereas only soot is a regulation target in the PM particle number regulation. For this reason, the number of PM particles in exhaust gas may not be accurately detected using a value as a result of dividing by the average particle mass the PM weight obtained for the purpose of the detection of PM weight in exhaust gas.

### SUMMARY

According to the present disclosure, there is provided a sensor control device adapted for an engine including an exhaust passage along which an exhaust purification catalyst and a particulate matter detection sensor are disposed. The exhaust purification catalyst purifies a given gas component included in exhaust gas. The particulate matter detection sensor includes an attaching part, to which conductive particulate matter included in exhaust gas is attached, the particulate matter including a plurality of components. The particulate matter detection sensor is configured to output a detection signal that is in accordance with a weight of the particulate matter attached to the attaching part. The particulate matter detection sensor includes an upstream detection sensor that is disposed on an upstream side of the exhaust purification catalyst in a flow direction of exhaust gas. The device includes a particle number calculation unit that is configured to calculate a particle number of the particulate matter in exhaust gas based on the detection signal outputted by the upstream detection sensor.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram roughly illustrating a configuration of an engine control system in accordance with a first embodiment;

FIG. 2 is an exploded perspective view illustrating a configuration of a main feature of a sensor element in accordance with the first embodiment;

FIG. 3 is a diagram illustrating an electrical configuration of a PM sensor in accordance with the first embodiment;

FIG. 4 is a flow chart illustrating a procedure for PM calculation processing in accordance with the first embodiment;

FIG. 5 is a comparison diagram illustrating comparison of components of PM in exhaust gas between on upstream and downstream sides of a catalyst in accordance with the first embodiment;

FIG. 6 is a flow chart illustrating a procedure for PM particle number calculation processing of the first embodiment;

FIG. 7 is a diagram illustrating for each component a PM discharge amount (weight) detected on the upstream side of the catalyst in accordance with a second embodiment;

FIG. 8 is a flow chart illustrating a procedure for PM particle number calculation processing of the second embodiment;

FIG. 9 is a diagram illustrating abnormality diagnosis of the PM sensor in accordance with a modification; and

FIG. 10 is a flow chart illustrating a procedure for abnormality diagnosis of the PM sensor in accordance with a modification.

### DETAILED DESCRIPTION

### First Embodiment

A first embodiment will be described below with reference to the accompanying drawings. In the present embodiment, the amount of conductive particulate matter (PM) in exhaust gas discharged from an in-vehicle engine is monitored in a vehicle engine system including the engine. Particularly, a PM sensor is provided in an engine exhaust pipe, and the PM amount in exhaust gas is monitored based on the amount of PM attached to the PM sensor.

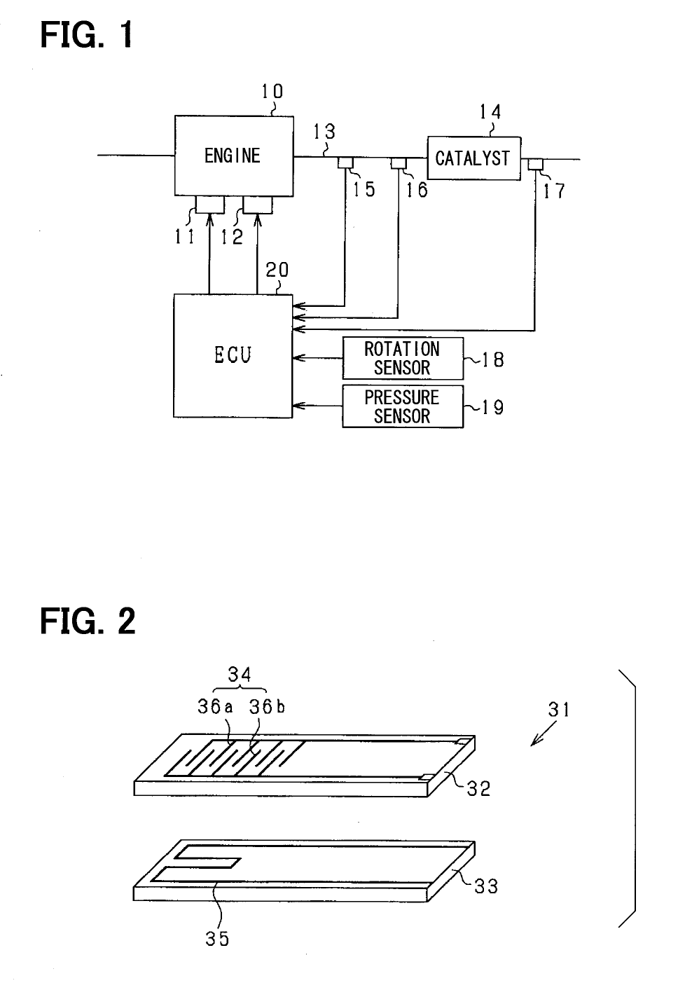

In FIG. 1, an engine 10 is a direct fuel-injection gasoline engine, and an injector 11 and an ignition device 12 are disposed for actuators in connection with operation of the engine 10. A three-way catalyst 14 serving as an exhaust purification catalyst is disposed in an exhaust pipe 13 of the engine 10. An air/fuel (NF) sensor 15 is provided on an upstream side of this three-way catalyst 14. The A/F sensor 15 is an exhaust gas sensor with a heater and a sensor element is heated through energization of the heater to have a predetermined active temperature.

The PM sensor serving as a particulate matter detection sensor is provided for the exhaust pipe 13. In regard to the PM sensor, particularly, the present system includes an upstream PM sensor 16 (upstream detection sensor) disposed on an upstream side of the three-way catalyst 14, and a downstream PM sensor 17 (downstream detection sensor) disposed on a downstream side of the three-way catalyst 14. In addition, for example, a rotation sensor 18 for detection of an engine rotation speed and a pressure sensor 19 for detection of an intake pipe pressure are provided in the present system.

An electronic control unit (ECU) 20 is configured to mainly include a microcomputer having a CPU (central processing unit), a ROM (read-only memory), and a RAM (random access memory) which are well known, and performs various controls of the engine 10 in accordance with an engine operation condition for each time by executing various control programs stored in the ROM. More specifically, respective signals are inputted into the ECU 20 from the above various sensors and so forth, and the ECU 20 calculates fuel injection quantity and ignition timing based on these various signals to control drives of the injector 11 and the ignition device 12. As for fuel injection control, the ECU 20 performs feed back control of air-fuel ratio based on a detection value of the A/F sensor 15.

The ECU 20 calculates the amount of PM discharged from the engine 10 (actual PM discharge amount) based on the detection signals of the PM sensors 16, 17, and performs engine control based on the calculated actual PM discharge amount. Specifically, the ECU 20 diagnoses a combustion state of the engine 10 based on the actual PM discharge amount, which is calculated based on the detection signals of the PM sensors 16, 17. If the actual PM discharge amount is larger than a predetermined abnormality determination value, the engine 10 is in a state of excessive discharge of PM from the engine 10, and the ECU 20 thereby determines that the engine 10 is abnormal. The ECU 20 may variably control the mode of control of the engine 10 based on the actual PM discharge amount, which is calculated based on the detection signals of the PM sensors 16, 17. For example, the ECU 20 can control fuel injection quantity, fuel injection timing, and ignition timing based on the actual PM discharge amount.

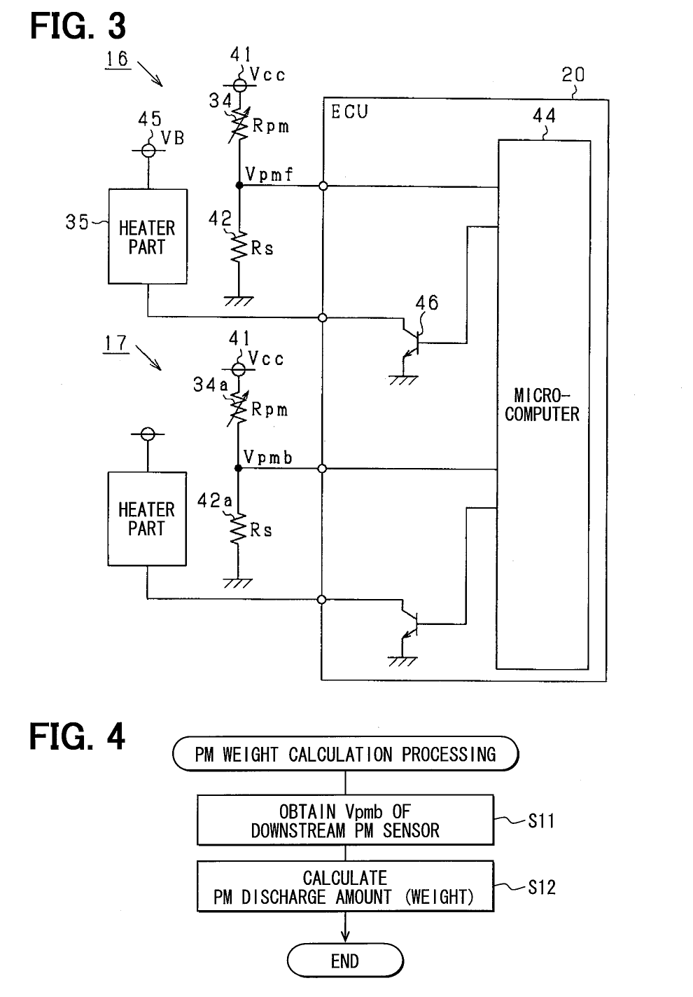

Configurations of the upstream PM sensor 16 and the downstream PM sensor 17, and an electric constitution of these PM sensors 16, 17 will be described below in reference to FIGS. 2 and 3. FIG. 2 is an exploded perspective view illustrating a configuration of a main feature of a sensor element 31 which constitutes the upstream PM sensor 16, and FIG. 3 is a diagram illustrating the electric constitution of the PM sensors 16, 17. The upstream PM sensor 16 and the downstream PM sensor 17 are different only in their positions of arrangement along the exhaust pipe 13, and have the same configuration. Thus, the configuration of the upstream PM sensor 16 will be described below, and explanation of the configuration of the downstream PM sensor 17 will be omitted.

As illustrated in FIG. 2, the sensor element 31 includes two sheets of insulating substrates 32, 33 having long plates shapes. A PM detecting part 34 for detection of the PM amount is provided for one insulating substrate 32, and a heater part 35 for heating the sensor element 31 is provided for the other insulating substrate 33. The sensor element 31 is configured by two-layered stacking the insulating substrates 32, 33. The insulating substrate 32 may correspond to an attaching part.

The insulating substrate 32 includes a pair of detection electrodes 36a, 36b, which are spaced from each other on its substrate face on the opposite side from the other insulating substrate 33. The PM detecting part 34 is constituted of the pair of detection electrodes 36a, 36b. The detection electrodes 36a, 36b are formed respectively in a pectinate shape having pectinate teeth, and the electrodes 36a, 36b are disposed to be opposed to each other with a predetermined distance therebetween, such that the pectinate teeth of the detection electrode 36a and the pectinate teeth of the detection electrode 36b are alternately arranged. The heater part 35 is constituted of a heating element made of, for instance, a heating wire. The shapes of the pair of detection electrodes 36a, 36b are not limited to the above shapes. The detection electrodes 36a, 36b may be formed in the shape of a curve or, the shapes of the detection electrodes 36a, 36b may be such that a pair of electrode parts respectively made of one line are disposed in parallel to be opposed to each other with a predetermined distance therebetween.

Although not shown, the upstream PM sensor 16 includes a holding portion for holding the sensor element 31, and the sensor element 31 is fixed to the exhaust pipe with its one end side held by the holding portion. In this case, the sensor 16 is disposed such that at least a part of the sensor 16 including the PM detecting part 34 and the heater part 35 is positioned in the exhaust pipe, and the upstream PM sensor 16 is attached to the exhaust pipe such that the insulating substrate 32 (PM attached part) faces the upstream side in the exhaust gas flow direction in the sensor element 31. Accordingly, when exhaust gas including PM flows in the exhaust pipe, this PM is attached and deposited on the detection electrodes 36a, 36b and their vicinity of the insulating substrate 32.

Because of change of a resistance value of the PM detecting part 34 (i.e., resistance value between the pair of detection electrodes 36a, 36b) and correspondence of the change of the resistance value to the PM deposition amount (weight) when PM in exhaust gas is attached and deposited on the insulating substrate 32 of the sensor element 31, the upstream PM sensor 16 having the above configuration calculates the amount of PM attached on the insulating substrate 32 using this change of the resistance value.

As illustrated in FIG. 3, for the electric constitution of the upstream PM sensor 16, a sensor power source 41 is connected to one end side of the PM detecting part 34 of the upstream PM sensor 16, and a shunt resistance 42 is connected to the other end side of the detecting part 34. In this case, a voltage-dividing circuit is formed from the PM detecting part 34 and the shunt resistance 42, and an intermediate point voltage therebetween is inputted into the ECU 20 as a PM detection voltage Vpmf (sensor detection value). More specifically, a resistance value Rpm changes in accordance with the PM deposition amount (weight) at the PM detecting part 34, and the PM detection voltage Vpmf changes with this resistance value Rpm and a resistance value Rs of the shunt resistance 42. Then, this PM detection voltage Vpmf is inputted into the microcomputer 44 (particle number calculation unit, operational state detection unit, estimation unit, downstream weight calculation unit, upstream weight calculation unit, abnormality diagnosis unit, particular component amount calculation unit, setting unit). The microcomputer 44 calculates the amount (weight) of PM attached on the PM detecting part 34 according to the inputted PM detection voltage Vpmf.

A heater power supply 45 is connected to the heater part 35 of the upstream PM sensor 16. The heater power supply 45 is, for example, an in-vehicle battery, and the heater part 35 is heated by an electric supply from the in-vehicle battery. In this case, a transistor 46 serving as a switching element is connected to a low-side of the heater part 35, and the transistor 46 is turned on or off by the microcomputer 44, so that the heating of the heater part 35 is controlled. As a result of the heating at the heater part 35 in a state in which PM is deposited on the insulating substrate 32, the temperature of deposited PM increases, and accordingly, the deposited PM is forcibly combusted. By such a forcible combustion, the PM deposited on the insulating substrate 32 is combusted and removed.

An electric constitution of the downstream PM sensor 17 is the same as the upstream PM sensor 16. Specifically, a resistance value Rpm changes in accordance with PM deposition weight at a PM detecting part 34a of the downstream PM sensor 17, and a PM detection voltage Vpmb changes with this resistance value Rpm and a resistance value Rs of a shunt resistance 42a. Then, this PM detection voltage Vpmb is inputted into the microcomputer 44. The microcomputer 44 calculates the amount (weight) of PM attached on the PM detecting part 34a according to the inputted PM detection voltage Vpmb.

PM amount calculation processing for calculating the PM amount in exhaust gas based on the detection signal of the PM sensor will be described. In the present embodiment, PM weight and PM particle number are calculated (estimated) for the PM amount in exhaust gas, and the amount of PM discharged from the engine 10 is monitored such that these do not exceed predetermined abnormality determination values. Respective calculation procedures will be explained below.

### <PM Weight>

Under the PM weight regulation, among the components of PM, the three components of soot, SOF, and sulfate are regulated. Among these, sulfate is generated as a result of oxidation of SOx produced by combustion by the three-way catalyst 14. Therefore, on the downstream side of the three-way catalyst 14, the three components of soot, SOF, and sulfate are included in exhaust gas. In view of this, in order to detect the PM weight, the PM weight in exhaust gas is calculated (estimated) using the detection signal (PM detection voltage Vpmb) from the downstream PM sensor 17 of the two PM sensors 16, 17 disposed along the exhaust pipe 13.

FIG. 4 is a flow chart illustrating a procedure for PM weight calculation processing. This processing is executed with a predetermined period by the microcomputer 44 of the ECU 20.

In FIG. 4, at S11, the PM detection voltage Vpmb of the downstream PM sensor 17 is obtained. At S12, the actual PM discharge amount (weight) is calculated based on the obtained PM detection voltage Vpmb. For example, a relationship between the PM detection voltage and PM weight is set beforehand and stored as a map for PM calculation, and by reading out the PM weight corresponding to the obtained value of the PM detection voltage Vpmb on the PM calculation map, the actual PM discharge amount is calculated. As regards the calculated actual PM discharge amount (weight), engine control using this actual PM discharge amount is implemented through another routine (not shown). Specifically, if the actual PM discharge amount is larger than a predetermined abnormality determination value α, the engine 10 is in a state of excessive discharge of PM with regard to the PM weight, and the ECU 20 thereby determines that the engine 10 is abnormal. Alternatively, fuel injection quantity, fuel injection time, or ignition timing may be controlled based on the actual PM discharge amount.

### <PM Particle Number>

As for the PM particle number, in the present embodiment, average particle mass of PM is set and stored beforehand, and the ECU 20 calculates the PM particle number by dividing the PM weight, which is calculated based on the detection voltage of the PM sensor, by the average particle mass.

Under the PM particle number regulation, among the components of PM, only soot is regulated. Sulfate, which is one component of PM, is generated as a result of oxidizing SOx discharged from the engine 10 by the three-way catalyst 14. Accordingly, before sulfate passes through the three-way catalyst 14, sulfate may not be included in exhaust gas or even if included, the amount of sulfate may be small.

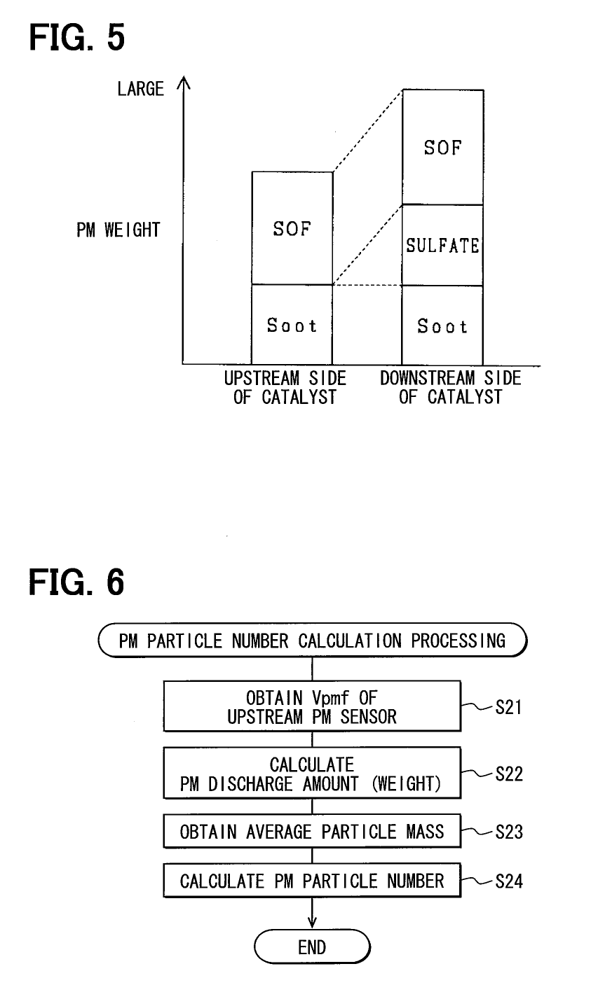

FIG. 5 is a diagram illustrating comparison of components of PM in exhaust gas between on upstream and downstream sides of the three-way catalyst 14. As illustrated in FIG. 5, soot and SOF are mainly included for PM on the upstream side of the three-way catalyst 14, and on the other hand, three components of soot, SOF, and sulfate are included for PM on the downstream side of the three-way catalyst 14. Moreover, the discharge amount of soot and SOF is generally the same on upstream and downstream sides of the three-way catalyst 14.

Accordingly, in the present embodiment, for the purpose of detection of the PM particle number, the amount of PM attached (PM weight) to the upstream PM sensor 16, i.e., the weight of PM included in exhaust gas on the upstream side of the catalyst, is calculated based on the detection signal (PM detection voltage Vpmf) of the upstream PM sensor 16 of the two PM sensors (the upstream PM sensor 16 and the downstream PM sensor 17). In addition, the PM particle number in exhaust gas is calculated by dividing this calculated PM weight by the average particle mass. The PM weight calculated based on the detection signal of the upstream PM sensor 16 is basically the total amount of weights of Soot and SOF attached to the upstream PM sensor 16. Therefore, the PM particle number can be calculated with the exclusion of the weight of sulfate.

The processing in FIG. 6 is executed with a predetermined period by the microcomputer 44 of the ECU 20.

In FIG. 6, the PM detection voltage Vpmf of the upstream PM sensor 16 is obtained at S21. At S22, the actual PM discharge amount (weight) is calculated based on the obtained PM detection voltage Vpmf. At S23, the PM average particle mass is obtained. In the present embodiment, the PM average particle mass is set and stored beforehand, and the stored value is read out. Then, at S24, the PM particle number is calculated through division of the actual PM discharge amount by the PM average particle mass.

As regards the calculated PM particle number (actual PM particle number), engine control using the actual PM particle number is implemented through another routine (not shown). Specifically, if the actual PM particle number is larger than a predetermined abnormality determination value β, the engine 10 is in a state of excessive discharge of PM with regard to the PM particle number, and the ECU 20 thereby determines that the engine 10 is abnormal. Alternatively, fuel injection quantity, fuel injection time, or ignition timing may be controlled based on the actual PM particle number.

According to the present embodiment described in detail above, the following excellent effects are produced.

The PM sensor is disposed on the upstream side of the three-way catalyst 14 serving as an exhaust purification catalyst. The number of PM particles in exhaust gas is calculated based on the PM detection voltage Vpmf of the upstream PM sensor 16. On the downstream side of the three-way catalyst 14, three components of soot, SOF, and sulfate are included in exhaust gas as PM. On the upstream side of the catalyst 14, sulfate is not included in exhaust gas, or its amount is small even if sulfate is included. Accordingly, compared to the calculation based on the PM detection voltage Vpmb of the downstream PM sensor 17 disposed on the downstream side of the three-way catalyst 14, the number of PM particles included in exhaust gas (particle number of Soot) can be detected with a high degree of accuracy.

For the PM sensor, the downstream PM sensor 17 is further disposed on the downstream side of the three-way catalyst 14. Accordingly, depending on the detection of the weight of PM in exhaust gas or detection of the number of PM particles in exhaust gas, either one of the PM detection voltages on upstream and downstream sides of the three-way catalyst 14 can be selectively used. Specifically, under the PM weight regulation, since three components of soot, SOF, and sulfate are regulation targets, for the purpose of detection of PM weight, the PM weight is calculated based on the PM detection voltage Vpmb of the downstream PM sensor 17, and this calculated PM weight is used for the detection purpose. On the other hand, because only soot is a regulation target under the PM particle number regulation, for the purpose of detection of PM particle number, the PM particle number is calculated based on the PM detection voltage Vpmf of the upstream PM sensor 16, and this calculated PM particle number is used for the detection purpose.

### Second Embodiment

Next, a second embodiment will be described below with a focus on its different features from the first embodiment. In the present embodiment, an operational state of an engine 10 is detected, and under the condition that the detected engine operating state is a predetermined high-load operation state, the PM particle number is calculated based on a PM detection voltage Vpmf of an upstream PM sensor 16.

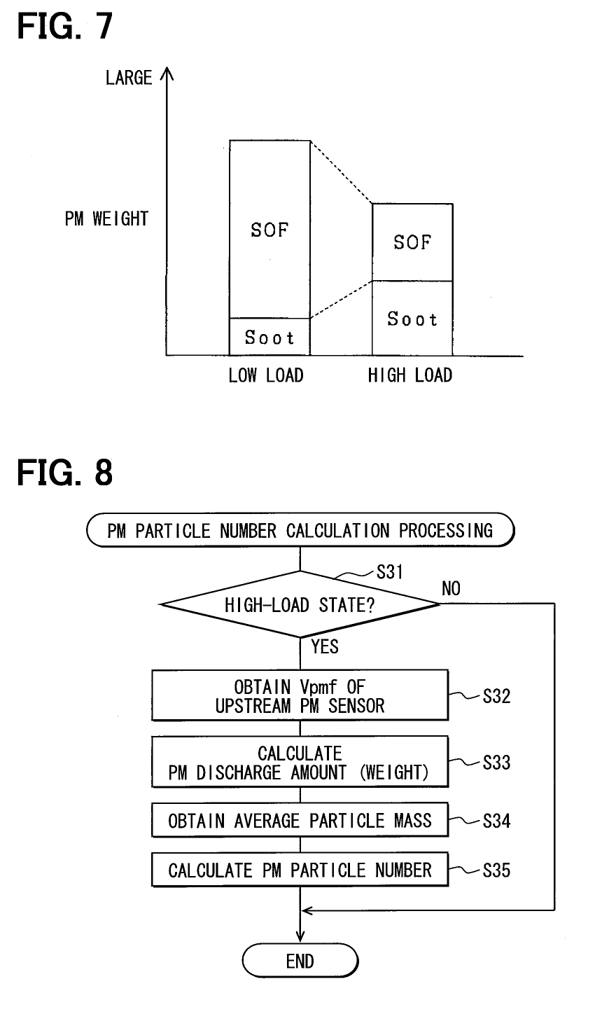

By the upstream PM sensor 16, detection of sulfate of components of PM can be excluded, but detection of SOF cannot be excluded. As a result of examination by the inventor, the amount of each component of PM discharged from the engine 10 is different according to the magnitude of the engine load. Specifically, as illustrated in FIG. 7, at the time of an engine high load, the amount of soot discharged from the engine 10 is larger and the amount of SOF is smaller than at the time of a low load. Furthermore, a ratio of each component contained in PM to the entire amount of PM in exhaust gas is different according to the engine load, and at the time of the engine high load, the rate of SOF in PM is small as compared to at the time of the low load. Consequently, when the PM particle number is calculated based on the detection signal of the upstream PM sensor 16, at the time of the engine high load, the influence of SOF may be small compared with at the time of the low load. Thus, in the present embodiment, under the condition that the engine 10 is in a high load state, the PM particle number is calculated based on the PM detection voltage Vpmf of the upstream PM sensor 16.

FIG. 8 is a flow chart illustrating a procedure for PM particle number calculation processing. The processing in FIG. 6 is executed with a predetermined period by the microcomputer 44 of the ECU 20. In addition, explanation of the same processing as in FIG. 6 in the first embodiment will be omitted using the step numbers (S) in FIG. 6.

In FIG. 8, it is determined at S31 whether the operational state of the engine 10 is a predetermined high load state. Specifically, if an engine rotation speed detected by a rotation sensor 18 is equal to or higher than a determination value, and an intake pipe pressure detected by a pressure sensor 19 is equal to or higher than a determination value, the predetermined high load state is determined. If the engine 10 is in a high load state, control proceeds to S32 to S35 at which similar processing to S21 to S24 in FIG. 6 is executed, and the present processing is ended.

According to the present embodiment described in detail above, the following excellent effects are produced.

Based on the above relationship in FIG. 7, under the condition that the engine 10 is in a predetermined high load state, the PM particle number is calculated based on the PM detection voltage Vpmf of the upstream PM sensor 16. The sulfate content is not included in the PM weight calculated based on the PM detection voltage Vpmf of the upstream PM sensor 16, or its amount is small even if sulfate is included, but the SOF content is included in the PM weight. In view of this, as a result of the above configuration, the influence of SOF can be made as small as possible at the time of calculation of the PM particle number. Accordingly, accuracy in detection of the PM particle number can be further improved.

Modifications of the above embodiments will be described. The present disclosure is not limited to the description of the above embodiments, and may be embodied, for example, as follows.

In the above embodiments, the upstream PM sensor 16 is disposed on the upstream side of the three-way catalyst 14, and the downstream PM sensor 17 is disposed on the downstream side of the catalyst 14. Alternatively, the PM sensor may be disposed only on the upstream side of the three-way catalyst 14, and the number of PM particles in exhaust gas is calculated based on its PM detection voltage Vpmf.

In the PM sensor, due to, for example, reduction of a part of reactivity of the pectinate teeth electrodes, abnormality in sensor characteristics of shift of the actual amount of PM attached relative to the PM detection voltage can be caused. When the sensor characteristic abnormality is caused, accuracy in detection of the amount of PM discharged from the engine 10 is reduced. For example, the weights of soot and SOF hardly change between on upstream and downstream sides of the three-way catalyst 14. However, when the sensor characteristic abnormality is caused in either one of the upstream PM sensor 16 and the downstream PM sensor 17, a difference in the total amount of soot and SOF is caused between the upstream PM sensor 16 and the downstream PM sensor 17. In this case, for example, the value calculated based on the detection value of the upstream PM sensor 16, and the detection value of the downstream PM sensor 17 may indicate a value impossible given the actual engine operating state.

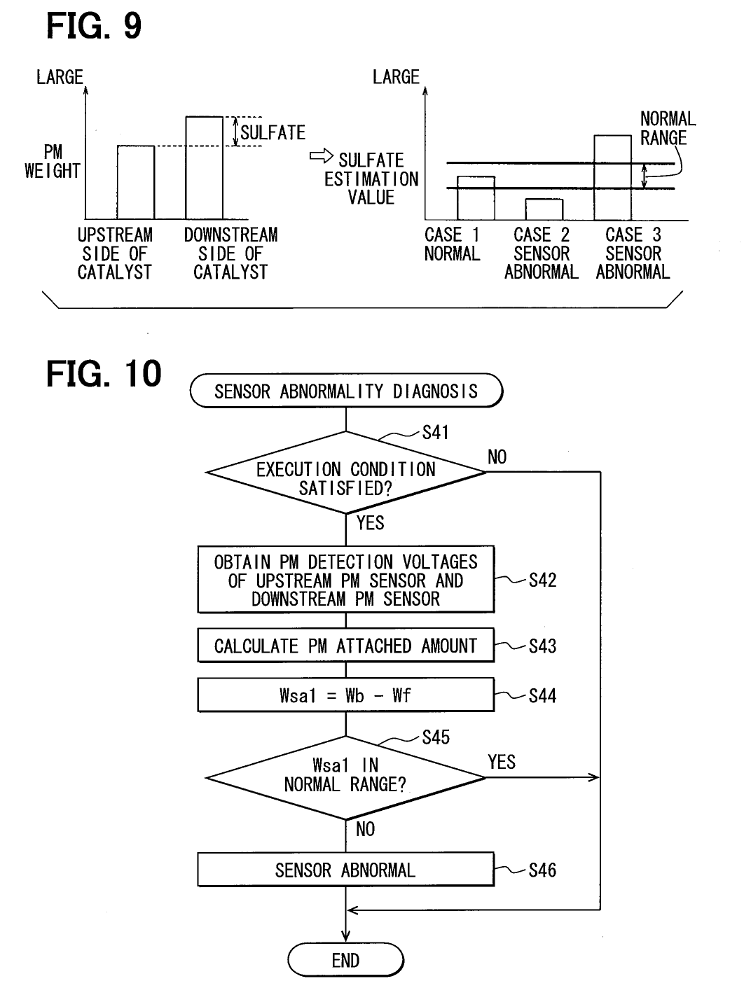

In view of this, in the present configuration, based on the PM weight (upstream PM weight) calculated based on the PM detection voltage of the upstream PM sensor 16, and the PM weight (downstream PM weight) calculated based on the PM detection voltage of the downstream PM sensor 17, abnormality diagnosis of the PM sensors 16, 17 is implemented. More specifically, based on the PM detection voltage of the upstream PM sensor 16, and the PM detection voltage of the downstream PM sensor 17, the actual amount of sulfate included in exhaust gas on the downstream side of the catalyst can be calculated. However, at the time of the abnormality of the PM sensor, as illustrated in FIG. 9, this calculated amount of sulfate indicates a value impossible given the actual engine operating state. More specifically, when the PM sensor is normal, the amount of sulfate obtained by subtraction of the upstream PM weight from the downstream PM weight is not beyond a normal range estimated from the actual engine operating state. When the sensor is abnormal, as illustrated in FIG. 9, the amount of sulfate obtained by subtraction of the upstream PM weight from the downstream PM weight becomes excessively large or small. With a focus on this, in the present embodiment, based on the downstream PM weight and upstream PM weight calculated using the PM detection voltages of the PM sensors, the weight of the particular component (sulfate) of the components of PM included in exhaust gas on the downstream side of the three-way catalyst 14 is calculated. Abnormality diagnosis of the upstream PM sensor 16 and the downstream PM sensor 17 is implemented based on the calculated weight of the particular component.

FIG. 10 is a flow chart illustrating a procedure for abnormality diagnosis of the PM sensor. This processing is executed with a predetermined period by the microcomputer 44 of the ECU 20. In FIG. 10, it is determined at S41 whether an execution condition for the sensor abnormality diagnosis is satisfied. For example, as for the execution condition, it is determined whether the engine 10 is in steady operation, and it is assumed that the execution condition is satisfied in the case of a steady operation state. If the execution condition is satisfied, control proceeds to S42, where the PM detection voltage Vpmf of the upstream PM sensor 16 and PM detection voltage Vpmb of the downstream PM sensor 17 are obtained, respectively. At S43, the PM attachment amount (upstream PM attachment amount Wf and downstream PM attachment amount Wb) is calculated based on the respective PM detection voltages.

At S44, the upstream PM attachment amount Wf is subtracted from the downstream PM attachment amount Wb, so that a weight Wsal of the sulfate component which is attached to the downstream PM sensor 17 is calculated. At S45, it is determined whether the calculated weight Wsal is within the normal range. In the present embodiment, the normal range is set based on the engine operating state at each time. Specifically, a relationship between the engine operating state (e.g., engine rotation speed, engine load) and a normal range of sulfate included in exhaust gas is set and stored beforehand, and the normal range of sulfate corresponding to the present engine operating state is set using this relationship. As for the relationship between the engine operating state and the normal range of sulfate, with a focus, for example, on the fact that concentration of SOx discharged from the engine becomes higher at the time of the engine higher load and the amount of sulfate included in exhaust gas consequently increases, an upper limit of the normal range is increased at the time of a higher engine load. In addition, for example, a fixed value, may be employed for a lower limit of the normal range. Then, if the weight Wsal of sulfate is out of the normal range, control proceeds to S46 to determine that the sensor characteristic is abnormal.

At S45, the normal range of sulfate is set based on the present engine operating state. Alternatively, instead of setting the normal range in accordance with the engine operating state, a predetermined range may be used for the normal range.

As illustrated in FIG. 7, a rate of the SOF component in PM discharged from the engine 10 differs according to the engine operating state. Specifically, at the time of the engine higher load, a ratio of the included soot component is higher, and a ratio of the included SOF component is lower. In view of this, in the present embodiment, among the components included in PM, the contained amount of a component (soot) that is the object of the particle number regulation is estimated based on the operational state of the engine 10. In addition, based on the estimated contained amount of soot, the number of PM particles in exhaust gas is calculated. Accordingly, the amount of Soot discharged from the engine 10 can be accurately understood, and accuracy in detection of the PM particle number can thereby be further improved.

Specifically, for example, the PM weight calculated based on the PM detection voltage Vpmf of the upstream PM sensor 16 is multiplied by a correction coefficient f1 (<1) which is in accordance with the engine load (estimation unit or estimation means). As to the correction coefficient f1, specifically, as the engine load is higher, a larger value is set for the correction coefficient f1. Additionally, the value obtained by this multiplication between the PM weight and the correction coefficient f1 corresponds to an estimate value of the amount of soot discharged from the engine 10. The PM particle number is calculated through the division of the value obtained by this multiplication by the average particle mass of PM.

In the foregoing second embodiment, on condition that the engine 10 is in a predetermined high load state, the PM particle number is calculated based on the PM detection voltage Vpmf of the upstream PM sensor 16. In the present modification, irrespective of whether the engine load is large or small, the PM particle number is calculated based on the PM detection voltage Vpmf of the upstream PM sensor 16; and if the engine 10 is in a predetermined high load state, the PM particle number is calculated using without any change the PM weight calculated based on the PM detection voltage Vpmf (correction coefficient f1=1). On the other hand, if the engine 10 is not in a predetermined high load state, multiply the PM weight calculated based on the PM detection voltage Vpmf by the correction coefficient f1 which is in accordance with the engine load, and the PM particle number is calculated using the value obtained by this multiplication. As a result of this configuration, the PM particle number can be calculated with a high degree of accuracy regardless of the engine operating state.

In the above embodiments, the application of the device of the present disclosure to the direct fuel-injection gasoline engine has been illustrated. Alternatively, the device may be applied to a port-injection gasoline engine, in which an injector is disposed near an intake port, and the present disclosure can be used for a PM sensor disposed in an exhaust pipe of the engine.

To sum up, the sensor control device of the above embodiments can be described as follows.

A sensor control device is adapted for an engine 10 including an exhaust passage 13 along which an exhaust purification catalyst 14 and a particulate matter detection sensor 16, 17 are disposed. The exhaust purification catalyst 14 purifies a given gas component included in exhaust gas. The particulate matter detection sensor 16, 17 includes an attaching part 32, to which conductive particulate matter included in exhaust gas is attached, the particulate matter including a plurality of components. The particulate matter detection sensor 16, 17 is configured to output a detection signal that is in accordance with a weight of the particulate matter attached to the attaching part 32. The particulate matter detection sensor 16, 17 includes an upstream detection sensor 16 that is disposed on an upstream side of the exhaust purification catalyst 14 in a flow direction of exhaust gas. The device includes a particle number calculation unit 44, S24, S35 that is configured to calculate a particle number of the particulate matter in exhaust gas based on the detection signal outputted by the upstream detection sensor 16.

In short, among the components (soot, SOF, sulfate) included in the particulate matter, sulfate is generated through the oxidation of SOx discharged from the engine 10 by the exhaust purification catalyst 14. Under particle number regulation for the particulate matter, only soot is a regulation target out of the respective components of the particulate matter, and sulfate is not regulated. By focusing on these points, in the present configuration, the particulate matter detection sensor 16 is disposed on the upstream side of the exhaust purification catalyst 14, and the particle number of the particulate matter in exhaust gas is calculated based on its detection signal. As a result of this configuration, because sulfate is not included as a component of the particulate matter detected by the sensor 16, the particle number of the particulate matter included in exhaust gas (particle number of soot) can be accurately detected, compared with the case of use of the particulate matter detection sensor 17 disposed on the downstream side of the catalyst 14, for example.

The sensor control device may further include an operational state detection unit 44, S31 that is configured to detect an operational state of the engine 10. The particle number calculation unit 44, S35 may calculate the particle number of the particulate matter when the operational state detected by the operational state detection unit 44, S31 is a predetermined high-load operation state.

By the particulate matter detection sensor 16 disposed on the upstream side of the exhaust purification catalyst 14. The amount of the particulate matter is detected with, the SOF component which is not the object for regulation of the particle number in addition to the soot component which is subject to the particle number regulation, included therein. As a result of the examination by the inventor, the amount of each component of the particulate matter discharged from the engine 10 varies according to the engine operating state. Specifically, at the time of the high load of the engine 10, it is found that the discharge amount of soot is larger and the discharge amount of SOF is smaller than at the time of the low load (see FIG. 7). Therefore, the rate of each component of the particulate matter in exhaust gas varies with the engine operating state; and at the time of the engine high load, a rate of SOF to the entire discharge amount of the particulate matter is smaller than at the time of the low load. Based on this finding, it may be said that, at the time of the engine high load, influence of SOF can be made smaller at the time of calculation of the particle number. Thus, as in the present configuration, through the calculation of the particle number of the particulate matter based on the sensor detection signal at the time of the engine high load, accuracy in detection of the particle number can be further improved.

The sensor control device may further include an estimation unit 44 that is configured to estimate an amount of a component, which is included in the particulate matter and is an object of particle number regulation, out of the plurality of components based on an operational state of the engine 10. The particle number calculation unit 44, S24 may calculate the particle number of the particulate matter based on the amount of the component, which is included in the particulate matter and is the object of particle number regulation.

The rate of the SOF component in the particulate matter discharged from the engine 10 is different depending on the engine operating state. As the engine load becomes higher, the ratio of the included soot component is higher, and the ratio of the included SOF component is lower (see FIG. 7). In view of this, as a result of the above configuration, the amount of soot discharged from the engine 10 can be calculated with a high degree of accuracy. Eventually, accuracy in detection of the particle number of the particulate matter can be further increased.

The particulate matter detection sensor 16, 17 may further include a downstream detection sensor 17 that is disposed on a downstream side of the exhaust purification catalyst 14 in the flow direction of exhaust gas. The device may further include a downstream weight calculation unit 44, S12 that is configured to calculate the weight of the particulate matter attached, based on the detection signal outputted by the downstream detection sensor 17.

The object of particle number regulation is soot, while the objects of weight regulation are three components: soot, SOF, and sulfate. In this regard, as a result of the present configuration, depending on the detection of the weight of particulate matter in exhaust gas or detection of the number of particles in exhaust gas, either one of the sensor detection signals on upstream and downstream sides of the catalyst 14 can be selectively used. Accordingly, the discharge amount (weight and particle number) of particulate matter can be accurately detected.

By the particulate matter detection sensor, there may be a difference of the actual amount of particulate matter attached (amount included in exhaust gas) from the sensor detection signal. When such abnormality in sensor characteristics is caused, it is thought that the amount of particulate matter in exhaust gas cannot be detected with sufficient accuracy.

The weights of soot and SOF are mainly detected on the upstream side of the catalyst 14, and the weights of soot, SOF, and sulfate are detected on the downstream side of the catalyst 14. For example, the weights of soot and SOF hardly change between on upstream and downstream sides of the exhaust purification catalyst 14. Therefore, among the amount of particulate matter detected by the particulate matter detection sensor, detection results of the components of soot and SOF should be the same between on upstream and downstream sides of the catalyst 14. However, if sensor characteristic abnormality is caused in either one of the particulate matter detection sensors 16, 17 disposed on upstream and downstream sides of the catalyst 14, the amounts of the components of soot and SOF detected respectively by the upstream sensor 16 and downstream sensor 17 are not the same between on upstream and downstream sides of the catalyst 14. In this case, for example, the value calculated based on the detection value of the upstream sensor 16 and the detection value of the downstream sensor 17 may indicate a value that is impossible given the actual engine operating state.

The sensor control device may further include: an upstream weight calculation unit 44, S22 that is configured to calculate a weight of the particulate matter in exhaust gas based on the detection signal outputted by the upstream detection sensor 16; and an abnormality diagnosis unit 44, S42-S46 that is configured to make abnormality diagnosis of the particulate matter detection sensor 16, 17 based on the weight of the particulate matter calculated by the upstream weight calculation unit 44, S22 and the weight of the particulate matter calculated by the downstream weight calculation unit 44, S12. As a result of this configuration, if abnormality in characteristics of the sensor is caused, this abnormality is detectable.

The abnormality diagnosis unit 44, S42-S46 may include: a particular component amount calculation unit 44, S44 that is configured to calculate a weight Wsal of a particular component, which is produced as a result of exhaust gas discharged from the engine 10 passing through the exhaust purification catalyst 14, out of the plurality of components of the particulate matter included in exhaust gas on the downstream side of the exhaust purification catalyst 14, based on the weight of the particulate matter calculated by the downstream weight calculation unit 44, S12 and the weight of the particulate matter calculated by the upstream weight calculation unit 44, S22; and a unit 44, S46 that is configured to make abnormality diagnosis of the particulate matter detection sensor 16, 17 based on the calculated weight Wsal of the particular component. By use of the detection results on upstream and downstream sides of the catalyst 14, the actual amount of sulfate (particular component) included in exhaust gas on the downstream side of the catalyst 14 can be calculated. If sensor characteristic abnormality is caused in either one of the particulate matter detection sensors 16, 17 disposed on upstream and downstream sides of the catalyst 14, the amount of sulfate calculated based on the detection value of the upstream sensor 16 and the detection value of the downstream sensor 17 indicates a value that is impossible given the actual engine operating state. Accordingly, sensor characteristic abnormality can be detected based on the amount of sulfate contained.

The sensor control device may further include a setting unit 44 that is configured to set a normal range of the weight Wsal of the particular component in the particulate matter based on an operational state of the engine 10. The abnormality diagnosis unit 44, S42-S46 may diagnose that the particulate matter detection sensor 16, 17 is abnormal when the weight Wsal of the particular component calculated by the particular component amount calculation unit 44, S44 is out of the normal range set by the setting unit 44. Since the weight of the particular component changes accordingly depending on the engine operating state, accuracy in diagnosis of sensor characteristic abnormality can be increased through a comparison between the normal range that is in accordance with the engine operating state at each time, and the amount of the particular component calculated based on the sensor detection value.

Additional advantages and modifications will readily occur to those skilled in the art. The invention in its broader terms is therefore not limited to the specific details, representative apparatus, and illustrative examples shown and described.

What is claimed is:

1. A sensor control device adapted for an engine including an exhaust passage along which an exhaust purification catalyst and a particulate matter detection sensor are disposed, wherein:
the exhaust purification catalyst purifies a given gas component included in exhaust gas;
the particulate matter detection sensor includes an attaching part, to which conductive particulate matter included in exhaust gas is attached, the particulate matter including a plurality of components;
the particulate matter detection sensor is configured to output a detection signal that is in accordance with a weight of the particulate matter attached to the attaching part; and
the particulate matter detection sensor includes an upstream detection sensor that is disposed on an upstream side of the exhaust purification catalyst in a flow direction of exhaust gas, the device comprising a particle number calculation unit that is configured to calculate a particle number of the particulate matter in exhaust gas based on the detection signal outputted by the upstream detection sensor.

2. The sensor control device according to claim 1, further comprising an operational state detection unit that is configured to detect an operational state of the engine, wherein the particle number calculation unit calculates the particle number of the particulate matter when the operational state detected by the operational state detection unit is a predetermined high-load operation state.

3. The sensor control device according to claim 1, further comprising an estimation unit that is configured to estimate an amount of a component, which is included in the particulate matter and is an object of particle number regulation, out of the plurality of components based on an operational state of the engine, wherein the particle number calculation unit calculates the particle number of the particulate matter based on the amount of the component, which is included in the particulate matter and is the object of particle number regulation.

4. The sensor control device according to claim 1, wherein the particulate matter detection sensor further includes a downstream detection sensor that is disposed on a downstream side of the exhaust purification catalyst in the flow direction of exhaust gas, the device further comprising a downstream weight calculation unit that is configured to calculate the weight of the particulate matter attached, based on the detection signal outputted by the downstream detection sensor.

5. The sensor control device according to claim 4, further comprising:
an upstream weight calculation unit that is configured to calculate a weight of the particulate matter in exhaust gas based on the detection signal outputted by the upstream detection sensor; and
an abnormality diagnosis unit that is configured to make abnormality diagnosis of the particulate matter detection sensor based on the weight of the particulate matter calculated by the upstream weight calculation unit and the weight of the particulate matter calculated by the downstream weight calculation unit.

6. The sensor control device according to claim 5, wherein the abnormality diagnosis unit includes:
a particular component amount calculation unit that is configured to calculate a weight of a particular component, which is produced as a result of exhaust gas discharged from the engine passing through the exhaust purification catalyst, out of the plurality of components of the particulate matter included in exhaust gas on the downstream side of the exhaust purification catalyst, based on the weight of the particulate matter calculated by the downstream weight calculation unit and the weight of the particulate matter calculated by the upstream weight calculation unit; and
a unit that is configured to make abnormality diagnosis of the particulate matter detection sensor based on the calculated weight of the particular component.

7. The sensor control device according to claim 6, further comprising a setting unit that is configured to set a normal range of the weight of the particular component in the particulate matter based on an operational state of the engine, wherein the abnormality diagnosis unit diagnoses that the particulate matter detection sensor is abnormal when the weight of the particular component calculated by the particular component amount calculation unit is out of the normal range set by the setting unit.
